(19) United States
(12) Patent Application Publication
(10) Pub. No.: US 2025/0114742 A1
(43) Pub. Date: Apr. 10, 2025

(54) ACID GAS RECOVERY SYSTEM

(71) Applicant: DENSO CORPORATION, Kariya-city (JP)

(72) Inventors: Yoshiki MORIOKA, Kariya-city (JP); Yuki FUJITA, Kariya-city (JP); Shohei TANIGUCHI, Kariya-city (JP)

(21) Appl. No.: 18/906,204

(22) Filed: Oct. 4, 2024

(30) Foreign Application Priority Data
Oct. 10, 2023 (JP) 2023-175130

(51) Int. Cl. B01D 53/32

(52) U.S. Cl. CPC B01D 53/326; B01D 2257/504

(57) ABSTRACT

An acid gas recovery system includes an electrochemical cell and an electrolytic solution. The electrochemical cell includes a working electrode and a counter electrode and is configured to transfer electrons between the working electrode and the counter electrode in response to an application of a voltage between the working electrode and the counter electrode. The electrolytic solution is disposed between the working electrode and the counter electrode and contains at least a reducing agent configured to reduce reactive oxygen. At least one of the electrochemical cell and the electrolytic solution contains an adsorbing agent. The adsorbing agent is configured to adsorb an acid gas contained in an acid gas containing gas to recover the acid gas in accordance with supply of electrons from the counter electrode to the working electrode in response to an application of a first voltage between the working electrode and the counter electrode.

### CROSS REFERENCE TO RELATED APPLICATION

The present application claims the benefit of priority from Japanese Patent Application No. 2023-175130 filed on Oct. 10, 2023. The entire disclosure of the above application is incorporated herein by reference.

### TECHNICAL FIELD

The present disclosure relates to an acid gas recovery system.

### BACKGROUND

Conventionally, there has been known an acid gas recovery system that recovers an acid gas from a mixed gas containing the acid gas by electrochemical reactions in an electrochemical cell.

### SUMMARY

The present disclosure provides an acid gas recovery system that includes an electrochemical cell and an electrolytic solution. The electrochemical cell includes a working electrode and a counter electrode and is configured to transfer electrons between the working electrode and the counter electrode in response to an application of a voltage between the working electrode and the counter electrode. The electrolytic solution is disposed between the working electrode and the counter electrode and contains at least a reducing agent configured to reduce reactive oxygen. At least one of the electrochemical cell and the electrolytic solution contains an adsorbing agent. The adsorbing agent is configured to adsorb an acid gas contained in an acid gas containing gas to recover the acid gas in accordance with supply of electrons from the counter electrode to the working electrode in response to an application of a first voltage between the working electrode and the counter electrode.

### BRIEF DESCRIPTION OF DRAWINGS

Objects, features and advantages of the present disclosure will become apparent from the following detailed description made with reference to the accompanying drawings. In the drawings:

FIG. 1 is a diagram illustrating a carbon dioxide recovery system according to one embodiment;

FIG. 2 is a schematic view illustrating a configuration example of a carbon dioxide recovery device according to the one embodiment;

FIG. 3 is a cross-sectional view of an electrochemical cell according to the one embodiment;

FIG. 4A is a diagram for explaining the operation of the carbon dioxide recovery device in a carbon dioxide recovery mode; and

FIG. 4B is a diagram for explaining the operation of the carbon dioxide recovery device in a carbon dioxide discharge mode.

### DETAILED DESCRIPTION

Next, a relevant technology is described only for understanding the following embodiments. A carbon recovery system is an acid gas recovery system that recovers carbon dioxide (CO₂) gas as an acid gas. The carbon recovery system can be configured to concentrate an electric field on an electrode surface without using a redox active organic matter (for example, anthraquinone) and to adsorb CO₂ without charge transfer to CO₂.

However, when an electrochemical cell in the carbon recovery system is activated in the presence of oxygen (O₂), such as in the atmosphere, charge transfer to O₂ occurs, and reactive oxygen is produced. The generation of the reactive oxygen may cause decrease in current efficiency, which indicates the amount of CO₂ adsorbed per electron. Furthermore, the reactive oxygen having high reactivity may cause decomposition of an electrode material and the like that form the electrochemical cell, which may reduce a lifetime of the electrochemical cell.

An acid gas recovery system according to one aspect of the present disclosure is a system for separating, by chemical reactions, an acid gas from an acid gas containing gas that contains the acid gas and oxygen, and includes an electrochemical cell and an electrolytic solution. The electrochemical cell includes a working electrode and a counter electrode and configured to transfer electrons between the working electrode and the counter electrode in response to an application of a voltage between the working electrode and the counter electrode. The electrolytic solution is disposed between the working electrode and the counter electrode and contains at least a reducing agent configured to reduce reactive oxygen. At least one of the electrochemical cell and the electrolytic solution contains an adsorbing agent. The adsorbing agent is configured to adsorb the acid gas contained in the acid gas containing gas to recover the acid gas in accordance with supply of electrons from the counter electrode to the working electrode in response to an application of a first voltage between the working electrode and the counter electrode.

The acid gas recovery system according to the one aspect of the present disclosure can recover the acid gas from the acid gas containing gas by electrochemical reactions using the electrochemical cell including the electrolytic solution containing the reducing agent. Even when reactive oxygen is produced by the operation of the electrochemical cell, the reducing agent contained in the electrolytic solution is configured to decompose (reduce) the reactive oxygen, so that the influence of the reactive oxygen on a lifetime and a performance of the electrochemical cell can be reduced.

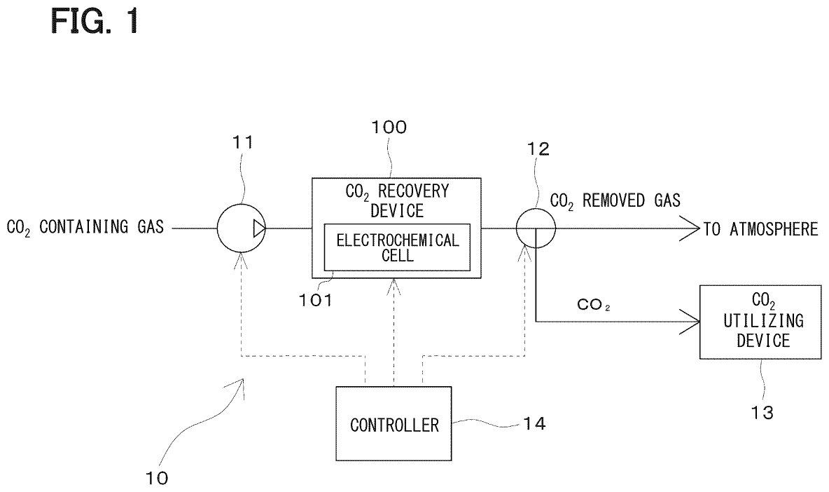

An embodiment of the present disclosure will be described with reference to FIGS. 1 to 4B. In the present embodiment, an acid gas recovery system of the present disclosure is realized as a carbon dioxide recovery system 10 for recovering carbon dioxide (CO₂), which is an example of an acid gas. In order to facilitate understanding, the same reference numerals are attached to the same constituent elements in each drawing where possible, and redundant explanations are omitted.

As shown in FIG. 1, the carbon dioxide recovery system 10 of the present embodiment includes a compressor 11, a carbon dioxide recovery device 100, a passage switching valve 12, a carbon dioxide utilizing device 13, and a controller 14.

The compressor 11 pumps a CO₂ containing gas to the carbon dioxide recovery device 100. The CO₂ containing gas is a mixed gas containing CO₂ and a gas other than CO₂, and for example, the atmosphere or exhaust gas of an internal combustion engine can be used as the CO₂ containing gas. The CO₂ containing gas contains O₂ as a gas other than CO₂.

The carbon dioxide recovery device 100 is a device that separates and recovers CO₂ from the CO₂ containing gas. The carbon dioxide recovery device 100 discharges a CO₂ removed gas that is gas after CO₂ is recovered from the CO₂ containing gas, or CO₂ recovered from the CO₂ containing gas. The configuration of the carbon dioxide recovery device 100 will be described in detail later.

The passage switching valve 12 is a three-way valve that switches a passage of exhaust gas from the carbon dioxide recovery device 100. The passage switching valve 12 switches the passage of the exhaust gas toward the atmosphere when the CO₂ removed gas is discharged from the carbon dioxide recovery device 100, and switches the passage of the exhaust gas toward the carbon dioxide utilizing device 13 when CO₂ is discharged from the carbon dioxide recovery device 100.

The carbon dioxide utilizing device 13 is a device that utilizes CO₂. The carbon dioxide utilizing device 13 may be a storage tank for storing CO₂ or a conversion device for converting CO₂ into fuel. As the conversion device, a device that converts CO₂ into a hydrocarbon fuel such as methane can be used. The hydrocarbon fuel may be gaseous fuel at normal temperature and pressure, or may be liquid fuel at normal temperature and pressure.

The controller 14 includes a well-known microcontroller including a central processing unit (CPU), a read only memory (ROM), a random access memory (RAM) and the like, and peripheral circuits thereof. The controller 14 performs various calculations and processes based on control programs stored in the ROM, and controls actuations of various devices connected to an output side of the controller 14. The controller 14 of the present embodiment performs an operation control of the compressor 11, an operation control of the carbon dioxide recovery device 100, a passage switching control of the passage switching valve 12 and the like.

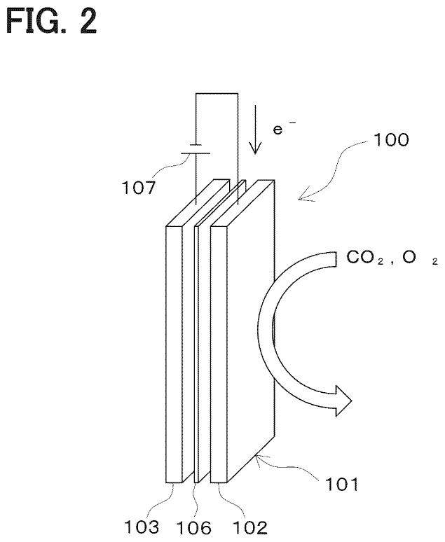

Next, the carbon dioxide recovery device 100 will be described with reference to FIG. 2. As shown in FIG. 2, the carbon dioxide recovery device 100 includes an electrochemical cell 101 configured to adsorb and desorb CO₂ by electrochemical reactions. The electrochemical cell 101 includes a working electrode 102, a counter electrode 103 and an insulating layer 106. In the example shown in FIG. 2, the working electrode 102, the counter electrode 103 and the insulating layer 106 are each formed in a plate shape. In FIG. 2, the working electrode 102, the counter electrode 103 and the insulating layer 106 are illustrated to have distances therebetween, but actually, these components are arranged to be in contact with each other.

The electrochemical cell 101 may be housed in a container (not shown). The container may define a gas inlet for introducing the CO₂ containing gas into the container and a gas outlet for discharging the CO₂ removed gas and CO₂ out of the container.

The carbon dioxide recovery device 100 is configured to adsorb and desorb CO₂ by the electrochemical reactions of the electrochemical cell 101, thereby separating and recovering CO₂ from the CO₂ containing gas. The carbon dioxide recovery device 100 includes a power supply 107 that applies a predetermined voltage to the working electrode 102 and the counter electrode 103, and can change a potential difference between the working electrode 102 and the counter electrode 103. The working electrode 102 is a negative electrode, and the counter electrode 103 is a positive electrode.

The electrochemical cell 101 can operate by changing the potential difference between the working electrode 102 and the counter electrode 103 by switching between a CO₂ recovery mode in which CO₂ is recovered from the CO₂ containing gas and a CO₂ discharge mode in which the recovered CO₂ is discharged from the electrochemical cell 101 to the outside. The CO₂ recovery mode is a charging mode for charging the electrochemical cell 101, and the CO₂ discharge mode is a discharging mode for discharging the electrochemical cell 101.

In the CO₂ recovery mode, a first voltage V1 is applied between the working electrode 102 and the counter electrode 103, and electrons flows from the counter electrode 103 to the working electrode 102. At the first voltage V1, the counter electrode potential is greater than the working electrode potential. The first voltage V1 can be in the range of, for example, 0.2 to 3.0 V, preferably 0.5 to 2.0 V.

It should be noted that in the CO₂ recovery mode, it is preferable that the potential applied to the working electrode 102 is set to be less than or equal to the equilibrium potential of the water electrolysis reaction and to be more than or equal to the equilibrium potential of oxygen+water reaction. Accordingly, it is possible to restrict side reactions such as hydrogen production among electrochemical reactions in the CO₂ recovery mode.

In the CO₂ discharge mode, a second voltage V2 is applied between the working electrode 102 and the counter electrode 103, and electrons flows from the working electrode 102 to the counter electrode 103. The second voltage V2 is different from the first voltage V1. The second voltage V2 is a voltage lower than the first voltage V1, and a magnitude relationship between the working electrode potential and the counter electrode potential is not limited. That is, in the CO₂ discharge mode, the working electrode potential may be lower than, equal to, or higher than the counter electrode potential.

In the electrochemical cell 101 of the present embodiment, when a voltage is applied between the working electrode 102 and the counter electrode 103, an electric double layer is formed by electrons and ions contained in an electrolytic solution 108. In the CO₂ recovery mode, when cations of the electrolytic solution 108 move to the vicinity of the working electrode 102 and anions of the electrolytic solution 108 move to the vicinity of the counter electrode 103, a potential difference is formed between the vicinity of the respective surfaces, and electrons are supplied from the counter electrode 103 to the working electrode 102.

The supply of electrons at the working electrode 102 facilitates the electrochemical reaction between water in the electrolytic solution 108 and O₂ contained in the CO₂ containing gas, thereby generating OH⁻. Water in the electrolytic solution 108 is an example of a reducing agent. Then, the electrochemical reaction between the produced OH⁻ and CO₂ contained in CO₂ containing gas produces carbon dioxide ions (CO₃²⁻) or hydrogen carbonate ions (HCO₃⁻). In addition, even if O₂⁻, which is reactive oxygen, is produced, O₂⁻ is decomposed by water contained in the electrolytic solution 108.

Since CO₂ in the CO₂ containing gas is used in the reaction to produce carbon dioxide ions or hydrogen carbonate ions, CO₂ in CO₂ containing gas is adsorbed and removed in accordance with the production of carbon dioxide ions or hydrogen carbonate ions, and CO₂ is recovered from CO₂ containing gas. OH⁻ contained in the electrolytic solution 108 is an example of an adsorbing agent.

Furthermore, CO₂ adsorption in the CO₂ recovery mode can also be carried out in a manner in which an adsorbent material is used together. The adsorbent material is a material whose chemical framework does not change when adsorbing an acid gas. The adsorbent material may be a material capable of transferring electrons without structural change of the chemical framework by an application of a negative potential to the counter electrode 103. The adsorbent material may also be a material in which charges are delocalized throughout the material without concentration of charges on specific elements in the chemical structure when electrons are supplied from the counter electrode 103. The adsorbent material is another example of the adsorbing agent.

Specifically, an organic compound can be used as the adsorbent material. For example, an aromatic compound can be used as the adsorbent material. It is desirable that the aromatic compound contains at least of N and S in the aromatic ring. N and S are elements having high electronegativity. In the organic compound, these elements having high electronegativity serve as acid gas adsorption sites. As the organic compound, for example, at least one selected from a group consisting of benzothiadiazole, polyvinylbenzothiadiazole and polydiazaphthalimide can be used.

In the CO₂ discharge mode, anions of the electrolytic solution 108 move to the vicinity of the working electrode 102, cations of the electrolytic solution 108 move to the vicinity of the counter electrode 103, and electrons are supplied from the working electrode 102 to the counter electrode 103.

In accordance with the supply of electrons from the counter electrode 103 to the working electrode 102, OH⁻ and the adsorbed CO₂ are dissociated from the carbonate ion (CO₃²⁻) or the hydrogen carbonate ion (HCO₃⁻) in the electrolytic solution 108. Thus, in the CO₂ recovery mode, CO₂ that has been adsorbed in the electrolytic solution 108 can be discharged and recovered from the electrochemical cell 101.

As the working electrode 102 of the electrochemical cell 101 according to the present embodiment, it is desirable to be a conductive material having gas permeability because the CO₂ containing gas is the target of CO₂ recovery. Furthermore, it is desirable that the working electrode 102 according to the present embodiment has a function to catalyze a reaction to produce OH⁻ using water contained in the electrolytic solution 108 and O₂ in CO₂ containing gas.

In order to realize the conductive material having gas permeability, the working electrode 102 is composed of a porous material having conductivity. In the present embodiment, a metal electrode composed of a porous material is employed as the working electrode 102. The metal electrode of the present embodiment has holes through which CO₂ containing gas can permeate. As the metal porous body constituting the working electrode 102, a foam mesh obtained by forming a metal into a mesh shape can be used.

Accordingly, a high specific surface area of the working electrode 102 can be achieved and the conductivity can be secured, and increase of an electrode interface and an air-liquid interface can promote a reaction when OH⁻ is produced from water in the electrolytic solution 108 and O₂.

Note that, as the porous material constituting the working electrode 102, a porous material including mesh and felt and a sintered body thereof can be used. It is also possible to employ porous carbon materials such as activated carbon, acetylene black, carbon nanotubes and graphene as the porous material.

The working electrode 102 according to the present embodiment is composed of a material that is active in the adsorption reaction. Specifically, the working electrode 102 can be formed using platinum (Pt), stainless steel (SUS), nickel (Ni), and the like. When a material active in the adsorption reaction is employed as a constituent material of the working electrode 102, it is possible to reduce an overvoltage during the electrochemical reactions and to improve the energy efficiency of the operation of the carbon dioxide recovery system 10.

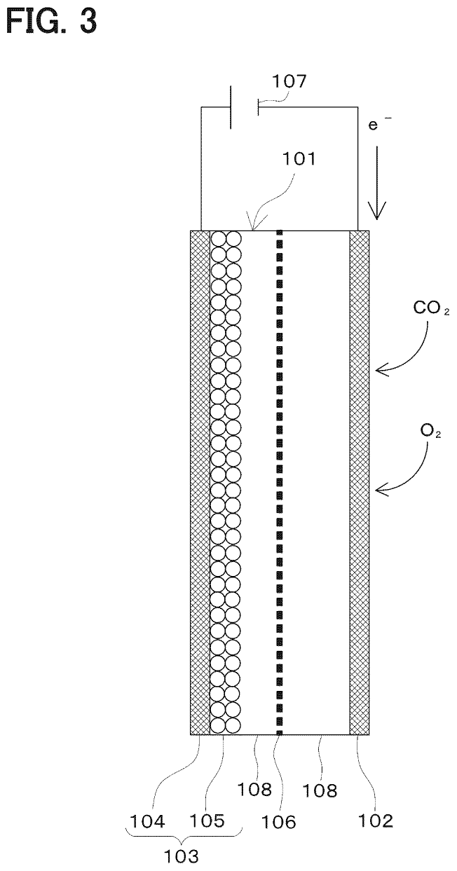

The counter electrode 103 of the electrochemical cell 101 according to the present embodiment includes an electrode that has a substance capable of donating electrons by changing the valence of elements in molecules or crystals when a potential is applied. As shown in FIG. 3, the counter electrode 103 includes a counter electrode base member 104 and a counter electrode active material 105. The counter electrode base member 104 is a conductive material. As the counter electrode base member 104, for example, a carbonaceous material or a metal material can be used. As the carbonaceous material constituting the counter electrode base member 104, for example, carbon paper, carbon cloth, non-woven carbon mat, porous gas diffusion layer (GDL) and the like can be used.

The counter electrode active material 105 may be, for example, a metal complex that can transfer electrons by changing a valence of a metal ion. Examples of such a metal complex include cyclopentadienyl metal complexes such as ferrocene, nickelocene, and cobaltocene, porphyrin metal complexes, and the like. These metal complexes may be polymers or monomers. In the present embodiment, polyvinylferrocene is used as the counter electrode active material 105. Ferrocene transfers electrons by changing the valence of Fe between divalent an trivalent.

Alternatively, the counter electrode active material 105 can be an auxiliary electroactive species that transfers electrons to and from the working electrode 102, and can also be a substance that can donate electrons by changing the valence of the elements in molecule or crystal when a potential is applied. For example, transition metal oxides of groups 5 to 11 of the periodic table can be used as the counter electrode active material 105. Preferably, the oxides of Cr, Mn, Fe, Co, Ni, Cu, Ru, Mo, Pd, Ag, more preferably the oxides of Cr, Mn, Fe, Ru can be used as the transition metal oxides.

The counter electrode active material 105 may have a characteristic of capturing ions (for example, electrolyte ions) in the electrolytic solution 108 during electrochemical reactions and not releasing protons in the electrolytic solution 108 when transferring electrons. The production of OH⁻ is not inhibited because protons are not released during transfer of electrons involved in the electrochemical reactions. As a result, recovery of CO₂ using OH⁻ in the electrolytic solution 108 and reduction of the influence by O₂⁻ can be certainly realized.

As shown in FIG. 3, the insulating layer 106 of the electrochemical cell 101 according to the present embodiment is disposed between the working electrode 102 and the counter electrode 103, and separates the working electrode 102 and the counter electrode 103. The insulating layer 106 is an insulating ion permeable membrane that prevents physical contact between the working electrode 102 and the counter electrode 103 to restrict an electrical short circuit and that allows ions to permeate therethrough.

As the insulating layer 106, a separator or a gas layer such as air can be used. In the present embodiment, a porous separator is used as the insulating layer 106. As the material of the separator, a cellulose membrane, a polymer, a composite material of a polymer and a ceramic, or the like can be used.

The electrolytic solution 108 having ionic conductivity is provided between the working electrode 102 and the counter electrode 103. The electrolytic solution 108 is provided between the working electrode 102 and the counter electrode 103 via the insulating layer 106. The electrolytic solution 108 is provided to cover the working electrode 102, the counter electrode 103 and the insulating layer 106.

The electrolytic solution 108 of the electrochemical cell 101 according to the present embodiment contains water as a solvent. Water also functions as a reducing agent. As a solute of the electrolytic solution 108, a salt containing one or more substances that ionize in the solvent is employed. The salt employed as the solute is a salt with a cation whose ionic potential is smaller than an ionic potential of lithium (Li). Specifically, sodium bis (fluorosulfonyl) imide (NaTFO), sodium bis (trifluoromethanesulfonyl) imide (NaTFSI), sodium perchlorate (NaClO₄), and the like can be used as the solute.

It should be noted that water in the electrolytic solution 108 is not limited to a mode contained in the electrolytic solution 108 in advance. For example, water may be added to the electrolytic solution 108 in a manner in which water contained in the CO₂ containing gas is incorporated into the electrolytic solution 108. A time when water is added to the electrolytic solution 108 is not limited to the operating state of the electrochemical cell 101.

The boiling point of the electrolytic solution 108 can be raised by a configuration in which a salt such as NaTFO is dissolved in the solvent. Accordingly, evaporation of the solvent in the electrolytic solution 108 can be restricted.

When the salt with the cation whose ionic potential is smaller than the ionic potential of lithium (Li) is employed as the solute of the electrolytic solution 108, it is possible to make the electrolytic solution 108 difficult to stabilize by chloride. As a result, adsorption and desorption of CO₂ can be realized by swing of the voltage in the electrochemical cell 101.

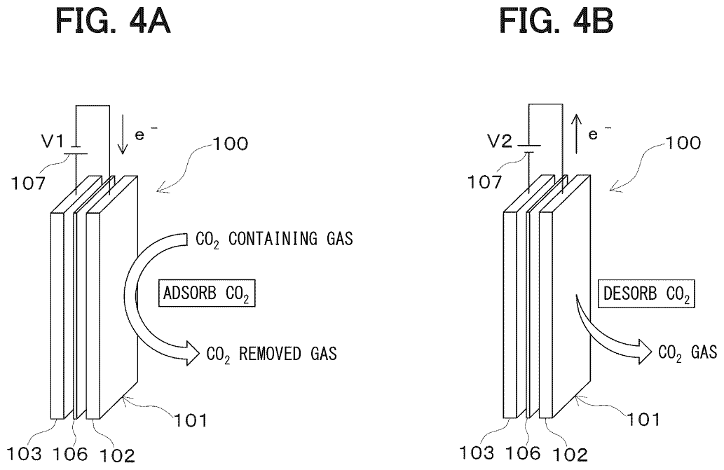

Next, an operation of the carbon dioxide recovery system 10 of the present embodiment will be described. The carbon dioxide recovery system 10 operates by alternately switching between the CO₂ recovery mode shown in FIG. 4A and the CO₂ discharge mode shown in FIG. 4B. The operation of the carbon dioxide recovery system 10 is controlled by the controller 14.

First, the CO₂ recovery mode will be described. In the CO₂ recovery mode, the compressor 11 operates to supply the CO₂ containing gas to the carbon dioxide recovery device 100. In the carbon dioxide recovery device 100, the voltage applied between the working electrode 102 and the counter electrode 103 is the first voltage V1. This makes it possible to simultaneously realize electron donation of the counter electrode active material 105 of the counter electrode 103 and electron attraction of the working electrode 102. The counter electrode active material 105 of the counter electrode 103 discharges electrons to be oxidized, and the electrons are supplied from the counter electrode 103 to the working electrode 102.

At the working electrode 102 in the CO₂ recovery mode, OH⁻ is produced using water in the electrolytic solution 108 and O₂ in the CO₂ containing gas in accordance with the supply of electrons from the counter electrode 103, as shown in the reaction formula (1).

2H₂O+O₂+4e⁻→4OH⁻ (1)

As shown in the reaction formula (2), OH⁻ produced at the working electrode 102 reacts with CO₂ contained in the CO₂ containing gas to produce hydrogen carbonate ions. At this time, CO₂ in the CO₂ containing gas is used to produce hydrogen carbonate ions. Thus, CO₂ is adsorbed and removed from the CO₂ containing gas.

OH⁻+CO₂→HCO₃⁻ (2)

In the CO₂ recovery mode, in addition to the adsorption method described above, it is also possible to adopt an adsorption method using the adsorbent material.

After CO₂ is recovered from the CO₂ containing gas by the carbon dioxide recovery device 100, the CO₂ containing gas is discharged from the carbon dioxide recovery device 100 as the CO₂ removed gas containing no CO₂. The passage switching valve 12 switches the passage of exhaust gas toward the atmosphere, and the CO₂ removed gas from the carbon dioxide recovery device 100 is discharged to the atmosphere.

It is assumed that, when the electrochemical cell 101 is activated in the carbon dioxide recovery device 100, a charge transfer to O₂ occurs, and superoxide O₂⁻, which is a kind of reactive oxygen, is produced. When superoxide O₂⁻ is produced, the high reaction activity of O₂⁻ causes decomposition of electrode materials and the like constituting the electrochemical cell, which may reduce the lifetime of the electrochemical cell in the carbon dioxide recovery system.

In this regard, in the carbon dioxide recovery device 100 according the present embodiment, since water is contained in the solvent of the electrolytic solution 108 of the electrochemical cell 101, even if O₂⁻ is produced by the operation of the electrochemical cell 101, the reactive oxygen is decomposed by water constituting the electrolytic solution 108. That is, the carbon dioxide recovery system 10 can restrict the influence of O₂⁻ on the electrode material, and can restrict the reduction of the lifetime of the electrochemical cell 101.

Next, the CO₂ discharge mode will be described. In the CO₂ discharge mode, the operation of the compressor 11 is stopped, and the supply of the CO₂ containing gas to the carbon dioxide recovery device 100 is stopped. In the carbon dioxide recovery device 100, the voltage applied between the working electrode 102 and the counter electrode 103 is the second voltage V2. This makes it possible to simultaneously realize electron donation of the working electrode 102 and electron attraction of the counter electrode active material 105 of the counter electrode 103. The counter electrode active material 105 of the counter electrode 103 receives electrons to be reduced.

When electrons are supplied from the working electrode 102 to the counter electrode 103, the electrons of OH⁻ of the electrolytic solution 108 are used, and water and O₂ are produced in the electrolytic solution 108 as shown in the reaction formula (3).

4OH⁻→O₂+H₂O+4e⁻ (3)

Then, in accordance with the supply of electrons from the working electrode 102 to the counter electrode 103, the hydrogen carbonate ions in the electrolytic solution 108 are dissociated into OH⁻ and CO₂ as shown in the reaction formula (4). In other words, CO₂ adsorbed in the CO₂ recovery mode is desorbed from the hydrogen carbonate ions and discharged from the electrolytic solution 108.

CO₃⁻→OH⁻+CO₂ (4)

The CO₂ discharged from the electrolytic solution 108 of the electrochemical cell 101 is discharged from the carbon dioxide recovery device 100. The passage switching valve 12 switches the passage of the exhaust gas toward the carbon dioxide utilizing device 13, and the CO₂ discharged from the carbon dioxide recovery device 100 is supplied to the carbon dioxide utilizing device 13.

Thus, according to the carbon dioxide recovery system 10, the recovery of CO₂ from CO₂ containing gas and the discharge of the recovered CO₂ to the carbon dioxide utilizing device 13 can be realized by alternately switching between the CO₂ recovery mode and the CO₂ discharge mode.

As described above, the carbon dioxide recovery system 10 according to the present embodiment includes the electrochemical cell 101 including the working electrode 102 and the counter electrode 103, and the electrolytic solution 108 containing at least water.

In the CO₂ recovery mode, when the first voltage V1 is applied between the working electrode 102 and the counter electrode 103, the reaction shown in the reaction formula (1) occurs in accordance with the supply of electrons from the counter electrode 103 to the working electrode 102, and OH⁻ is produced from water contained as the solvent and the reducing agent in the electrolytic solution 108. Then, as shown in the reaction formula (2), hydrogen carbonate ions and the like are produced by electrochemical reaction using the produced OH⁻ and CO₂ contained in the CO₂ containing gas. Since CO₂ contained in the CO₂ containing gas is used to produce the hydrogen carbonate ions and the like, or the carbon dioxide ions are generated, CO₂ can be adsorbed and removed from the CO₂ containing gas in the electrolytic solution 108 of the electrochemical cell 101 and the recovery of CO₂ can be realized.

In addition, even if the superoxide O₂⁻, which is the reactive oxygen, is generated in accordance with the operation of the electrochemical cell 101, in the present embodiment, since water as the reducing agent is included in the solvent of the electrolytic solution 108, the O₂⁻ can be used to generate OH⁻ by reaction with water. That is, even if O₂⁻ is produced, the carbon dioxide recovery system 10 can restrict the influence of O₂⁻ on the electrode material, and can restrict the reduction of the lifetime of the electrochemical cell 101.

Then, when the second voltage V2 is applied between the working electrode 102 and the counter electrode 103 in the CO₂ discharge mode, the OH⁻ and the CO₂ are dissociated from the hydrogen carbonate ions and the like in the electrolytic solution 108 in accordance with the supply of electrons to the counter electrode 103 as shown in the reaction formula (4).

As a result, the carbon dioxide recovery system can recover CO₂ adsorbed by the electrolytic solution 108 outside the electrochemical cell 101. Moreover, since the CO₂ recovery mode and the CO₂ discharge mode can be switched by changing the voltage applied between the working electrode 102 and the counter electrode 103, the two modes can be realized without major system changes.

Since the reducing agent has the property of reacting with the reactive oxygen to produce OH⁻ and is water which is a protic solvent, the energy required for adsorption and removal of CO₂, which is an acid gas, can be kept low. Moreover, since the reducing agent is added to the electrolytic solution 108 via a mist form or a gas form contained in the acid gas containing gas, it is sufficient if the reducing agent is contained in the electrolytic solution 108 during the electrochemical reaction, and recovery of the acid gas can be realized.

And, since the acid gas is CO₂, according to the carbon dioxide recovery system 10, the CO₂ recovered from the acid gas containing gas can be used in the carbon dioxide utilizing device 13 and the like.

The electrolytic solution 108 in the present embodiment contains water in the solvent and is composed of a salt including one or more substances that ionize in the solvent. When the electrolytic solution 108 includes the salt in addition to the solvent, the boiling point of the electrolytic solution 108 can be raised, and evaporation of the solvent of the electrolytic solution 108 can be restricted.

As the salt in the electrolytic solution 108 according to the present embodiment, the salt with the cation whose ionic potential is smaller than the ionic potential of Li is employed. When the salt with the cation whose ionic potential is smaller than the ionic potential of Li is employed, the electrolytic solution 108 can be made less stable by chloride. As a result, adsorption and desorption of CO₂ can be realized by swing of the voltage in the electrochemical cell 101.

The counter electrode 103 of the electrochemical cell 101 according to the present embodiment includes the electrode that has the substance capable of donating electrons by changing the valence of the elements in molecule or crystal when a potential is applied. As a result, the carbon dioxide recovery system 10 can improve the ability of the electrochemical cell 101 to donate electrons at the counter electrode 103. In addition, it is desirable that the active material at the counter electrode 103 has a characteristic of capturing electrolyte ions in the electrolytic solution 108 into the active material and not releasing protons in the electrolytic solution 108 when transferring electrons. This is because inhibition of the production of OH⁻ can be restricted by restricting the release of protons at the counter electrode 103.

The working electrode 102 of the electrochemical cell 101 according to the present embodiment is composed of a porous material having conductivity. Accordingly, a high specific surface area can be achieved while securing the conductivity of the working electrode 102 of the electrochemical cell 101, so that the electrode interface and the gas-liquid interface at the working electrode 102 can be increased and the OH⁻ formation reaction can be promoted.

In addition, the working electrode 102 of the electrochemical cell 101 according to the present embodiment is composed of a material that is active in the adsorption reaction, for example, stainless steel, platinum, and the like. When the working electrode 102 is composed of the above-described material, it is possible to reduce the reaction overvoltage in the electrochemical cell 101 and to improve the energy efficiency in the CO₂ recovery mode and the CO₂ discharge mode of the carbon dioxide recovery system 10.

### Other Embodiments

The present disclosure is not limited to the embodiments described above, and various modifications can be made as follows within a range not departing from the spirit of the present disclosure.

In the embodiment described above, an example has been described in which the working electrode 102 does not include a CO₂ adsorbent material. However, the present disclosure is not limited to this example. As long as the electrolytic solution 108 of the electrochemical cell 101 includes water, the working electrode 102 of the electrochemical cell 101 may include a CO₂ adsorbent material. Even when the working electrode 102 including a CO₂ adsorbent material is employed, because the electrolytic solution 108 contains water, the influence of O₂⁻ can be restricted by OH⁻ in the electrolytic solution 108 as in the embodiment described above. Also, in the embodiment described above, in the CO₂ recovery mode, the potential applied to the working electrode 102 is less than or equal to the equilibrium potential of the electrolytic reaction of water and is higher than or equal to the equilibrium potential of the reaction of oxygen+water. Thus, in the CO₂ recovery mode, the generation of side reactions such as hydrogen production can be restricted, and the CO₂ recovery efficiency from CO₂ containing gas can be improved.

In the embodiment described above, an example has been described in which water is included in the electrolytic solution 108. However, the present disclosure is not limited to this example. For example, the electrolytic solution 108 may include alcohols, phenols, ionic liquids, or glyme. In addition, the electrolytic solution 108 may be employed in a gel form or a solution form, or the electrolytic solution 108 may be employed in a form that is a solid electrolyte and partially contains water.

In the embodiment described above, an example has been described in which water as the reducing agent is contained in the electrolytic solution 108. However, the present disclosure is not limited to this example. The working electrode 102 or the counter electrode 103 may contain water as the reducing agent, or each combination including the electrolytic solution 108 may contain water as the reducing agent.

In the embodiment described above, an example has been described in which CO₂ as an acid gas is a target to be recovered. However, the present disclosure is not limited to this example. For example, other acid gases such as SOx and NOx may be recovery targets for acid gas recovery systems.

In the embodiment described above, an example has been described in which water is contained in advance as the solvent and the reducing agent of the electrolytic solution 108. However, the present disclosure is not limited to this example. Moisture contained in the acid gas in a mist from or a gas form may be added to the electrolytic solution 108 of the electrochemical cell 101.

What is claimed is:

1. An acid gas recovery system for separating, by chemical reactions, an acid gas from an acid gas containing gas that contains the acid gas and oxygen, comprising:
an electrochemical cell including a working electrode and a counter electrode and configured to transfer electrons between the working electrode and the counter electrode in response to an application of a voltage between the working electrode and the counter electrode; and
an electrolytic solution disposed between the working electrode and the counter electrode and containing at least a reducing agent configured to reduce reactive oxygen, wherein
at least one of the electrochemical cell and the electrolytic solution contains an adsorbing agent, and
the adsorbing agent is configured to adsorb the acid gas contained in the acid gas containing gas to recover the acid gas in accordance with supply of electrons from the counter electrode to the working electrode in response to an application of a first voltage between the working electrode and the counter electrode.

2. The acid gas recovery system according to claim 1, wherein the adsorbing agent is further configured to desorb the acid gas that has been adsorbed to recover the acid gas in response to an application of a second voltage different from the first voltage between the working electrode and the counter electrode.

3. The acid gas recovery system according to claim 1, wherein the reducing agent is configured to react with the reactive oxygen to produce OH⁻.

4. The acid gas recovery system according to claim 1, wherein the reducing agent is a protic solvent.

5. The acid gas recovery system according to claim 4, wherein the reducing agent is water.

6. The acid gas recovery system according to claim 1, wherein the reducing agent is added to the electrolytic solution via a mist form or a gas form contained in the acid gas.

7. The acid gas recovery system according to claim 1, wherein the acid gas is carbon dioxide.

8. The acid gas recovery system according to claim 1, wherein the electrolytic solution contains:
water as a solvent and the reducing agent, and
a salt including one or more substances that ionize in the water.

9. The acid gas recovery system according to claim 1, wherein the electrolytic solution contains a salt with a cation whose ionic potential is smaller than an ionic potential of lithium.

10. The acid gas recovery system according to claim 1, wherein the electrolytic solution contains the adsorbing agent.

11. The acid gas recovery system according to claim 2, wherein the reducing agent is configured to react with the reactive oxygen to produce OH⁻.

12. The acid gas recovery system according to claim 2, wherein the reducing agent is a protic solvent.

13. The acid gas recovery system according to claim 12, wherein the reducing agent is water.

14. The acid gas recovery system according to claim 2, wherein the reducing agent is added to the electrolytic solution via a mist form or a gas form contained in the acid gas.

15. The acid gas recovery system according to claim 2, wherein the acid gas is carbon dioxide.

16. The acid gas recovery system according to claim 2, wherein the electrolytic solution contains:
water as a solvent and the reducing agent; and
a salt including one or more substances that ionize in the water.

17. The acid gas recovery system according to claim 2, wherein the electrolytic solution contains a salt with a cation whose ionic potential is smaller than an ionic potential of lithium.

18. The acid gas recovery system according to claim 2, wherein the electrolytic solution contains the adsorbing agent.
